(19) United States
(12) Patent Application Publication
(10) Pub. No.: US 2009/0199428 A1
(43) Pub. Date: Aug. 13, 2009

(54) Method and apparatus for drying wood

(75) Inventor: Reino Pendikainen, Pajulahti (FI)

Correspondence Address: HARRINGTON & SMITH, PC, 4 RESEARCH DRIVE, Suite 202, SHELTON, CT, 06484-6212, US

(73) Assignee: Wood-Neste Oy

(21) Appl. No.: 12/380,814

(22) Filed: Mar. 3, 2009

Related U.S. Application Data
(63) Continuation of application No. PCT/FI2007/000214, filed on Aug. 31, 2007.

(30) Foreign Application Priority Data
Sep. 4, 2006 (FI) 20060791
Jul. 16, 2007 (FI) 20070550

(51) Int. Cl. F26B 3/00; F26B 21/06

(52) U.S. Cl. 34/517; 34/77

(57) ABSTRACT

The invention relates to a method and apparatus for drying wood by means of vapor. In the method according to the invention the vapor essentially is generated from the wood's own liquid by means of electric energy by conducting the electric energy by means of electrodes directly to the wood to be dried so that the vapor generated first in the center of the wood pushes out the liquids in the wood via the capillaries of the wood. The apparatus according to the invention includes a current source and electrodes connected thereto built to be brought into contact with the wood to be dried in order to conduct electricity to the wood.

### CROSS REFERENCE TO RELATED APPLICATION

This application is a continuation of International Patent Application No. PCT/FI2007/000214 filed on Aug. 31, 2007.

The invention relates to a method and apparatus for drying wood by means of vapor.

### BACKGROUND OF THE INVENTION

It is previously known to dry wood in quite many different ways, starting from the very traditional outdoor drying. Typically, the industry uses drying plants in which the moisture in the wood is evaporated by means of heat and airflow, and the humid air is removed from the drying space. A high-energy consumption is characteristic of these drying plants. Generally, the quality of the drying result could be much better. When aiming at a good drying result, the drying must be carried out quite gently, which, at the same time, signifies a long drying time.

It has been noticed that drying not only is a bottleneck but also a fairly important cost factor in the wood industry. Consequently, many different drying methods have been sketched out, based on various physical phenomena. Negative pressure, positive pressure and the alternation thereof in the drying space have been utilized. Microwaves, ultrasound and different radiations have also been proposed and even tested for the purpose of drying wood. There have been even more attempts but only a few methods have been applied industrially.

The invention aims at providing a method and apparatus by means of which the drying of wood takes place in a faster and more inexpensive way than before. The invention also aims at providing an apparatus which very well can be integrated into many kinds of production lines in the sawmill and wood product industry producing sawn timber, round logs and finished wooden objects.

### SUMMARY OF THE INVENTION

The invention according to the invention is based on the use of the liquid contained in the wood to conduct electricity through the wood. An electric current is connected to different sides of the wood, the electricity flowing through thus heating the liquid in the wood and converting the liquid into vapor whose high pressure drives the liquid out of the wood via the capillaries of the wood.

At the end, only vapor exits, and even this ceases as the electricity resistance of the wood increases during the drying of the wood. It should be noted that quite a large part of the liquid in the wood is removed from the wood expressly in the form of a liquid, whereby a considerable amount of energy is saved in comparison with the complete evaporation required in many of the previous methods.

### DESCRIPTION OF THE DRAWINGS

In the following, the invention will be looked at in the light of a preferred exemplary embodiment, which, however, does not restrict the invention.

FIG. 1 is a schematic view of an arrangement to carry out the method according to the invention.

In the Figure, numeral 1 denotes electrodes, numeral 2 denotes a current source, numeral 3 denotes the wood to be dried and numeral 4 denotes a trough to collect the liquids in the wood.

In the method according to the invention, the electrodes 1 are set on different sides of the wood 3 to be dried, into contact therewith, and electric energy 2 is conducted by means of the electrodes directly to the wood to be dried. When a high-voltage electric current from the current source 2 is conducted to the wood via the electrodes, the moisture in the wood starts to separate with the heating of the wood. The wood is typically driest at the center, the center thus having the highest electricity resistance. This means that it is the center of the wood 3 that starts to warm up first. As the water in the center evaporates, it drives water out of the wood 3 before it via the capillaries of the wood. The liquid falls into a trough 4 placed below the wood. At the end, there only is left a small amount of vapor, which is hotter and drier at the center of the wood 3 than farther out. The hotter and drier vapor also has a higher pressure and drives out the more humid vapor of the surface layers before it. After the exit of the vapor the wood is dried and has such a high resistance that the current supplied by the current source 2 drops substantially causing an automatic reduction in the energy consumption of the apparatus.

By observing the change in the electric current suitably with an amperemeter it is easy to keep up to date with how the drying proceeds. The drying result can be affected by altering the voltage, an increase in the voltage giving a better drying result. On the other hand, at the beginning of the drying, as a lot of liquid separates from the wood, it may be necessary to even decrease the voltage in order to avoid sparkling. Preferably, the electric voltage used is 200 V to 10 000 V, and preferably a few kilovolts in the range 2 to 7 kV.

The power consumption of the drying can be automatic or self-regulated, the apparatus thus decreasing the power as the wood dries.

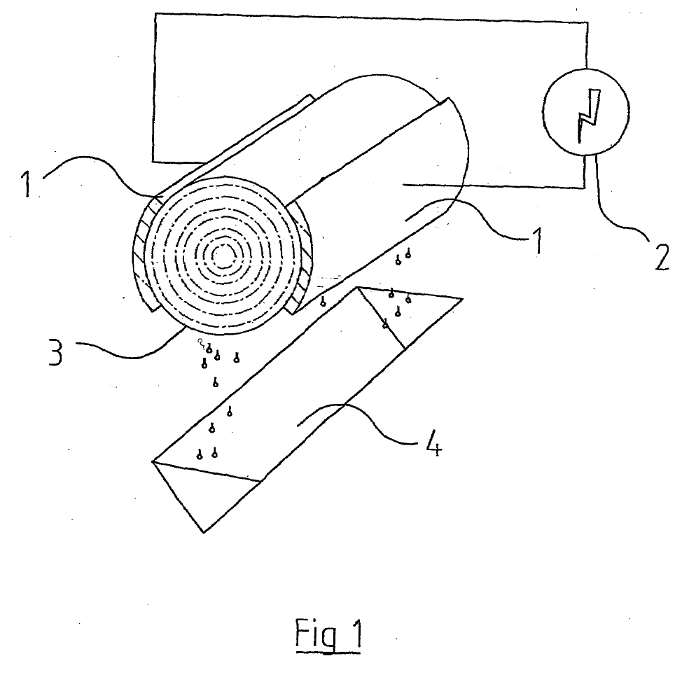

In putting into practice it is possible to use quite many different alternatives to carry out the invention. FIG. 1 illustrates the drying of a round piece of wood, such as a pole. However, it should have more application in the drying of sawn timber. Then, the electrodes used can be plate-like, and the sawn pieces of wood can lie there between adjacent to each other, spaced by small air gaps through which an air flow can be blown in order to lead out moisture. In the other electrode, lying farther down, or in close proximity thereto, a trough can be built to collect the liquid from which the liquid is let flow away to be recycled. The liquid is very suitable for the purposes of the chemical industry, for drugs and perfumes. If it is desirable to collect the liquids in the wood quite exhaustively, the drying can be arranged to take place in a hydrophobic light liquid, the entire apparatus thus lying in the liquid. Then, the liquids in the wood fall down to the bottom of the basin and are readily collectable therefrom. Naturally, this liquid must be non-conductive and fireproof.

The electrodes can also be perforated or otherwise permeable to vapor and/or liquid in order to enhance the removal of the vapor and liquid. To assure the flow of electricity, the contact surface of the electrodes with the wood can be provided with a sponge-like surface and a wetting device. If required, the wetting can be performed by using a liquid that is more electrically conductive, such as saline water.

If is desirable to increase the removal of liquid from the wood, at a given end thereof, the electrode can be divided into several part-electrodes lying one after another and having their power supply arranged into successive impulses, into a “running wave” or the like.

The removal of liquid into a desired direction can also be increased by making the upper electrode, for example, to resemble the belt of a caterpillar tractor, so as to be movable relative to the surface of the wood by means of rotating rollers, or in another way, the electrode thus being moved into the desired direction along the surface of the wood.

If there is extra or cheap heat energy available, the wood to be dried can be preheated to some extent, which reduces the electricity costs of the actual drying plant.

The efficiency of the apparatus is expected to be excellent, because no unnecessary warming up of drying chambers or similar spaces takes place and the drying only is exerted on the wood to be dried. Besides, no heat is transferred in pipelines all over the factory area.

As is apparent from the above, it is possible to carry out the invention is many different ways. The invention is, of course, susceptible of use together with the previously known drying methods. Therefore, the invention is not limited to the above-described examples but may vary within the scope of the claims.

1. A method of drying wood by means of vapor, in which
electrodes are placed on different sides of a wood to be dried,
said electrodes are brought into contact with the wood and electric energy is conducted to the wood by means of electrodes,
vapor is generated essentially from the wood's own liquid by means of electric energy, and
a drying result is controlled by means of voltage and so that the vapor generated first in the center of the wood pushes out the liquids in the wood via the capillaries of the wood.

2. A method as defined in claim 1, in which
a considerable part of the liquids in the wood is removed as liquids, which are collected into a trough.

3. A method as defined in claim 1, in which
said electrodes are divided into part-electrodes, and
an electric current is supplied thereto as successive running waves.

4. An apparatus for drying wood by means of vapor, comprising
a current source,
electrodes connected thereto and built to be brought into contact with a wood to be dried in order to conduct electricity to the wood,
controlling means for controlling of voltage and for controlling of drying of wood,
whereby the apparatus has been arranged to control the voltage so that the vapor generated first in the center of the wood pushes out the liquids in the wood via the capillaries of the wood.

5. An apparatus as defined in claim 4, in which
the electrodes are permeable to vapor and/or liquid.

6. An apparatus as defined in claim 4, in which
at least one of the electrodes is built to be moved along the surface of the wood.

7. An apparatus as defined in claim 4, in which
in the lower part of the apparatus is a trough for collecting a liquid separated from the wood.

8. An apparatus as defined in claim 7, in which
said through is large enough to contain such an amount of hydrophobic non-conductive fireproof liquid that the entire apparatus is suited to operate immersed in the liquid.

9. An apparatus as defined in claim 4, in which
said electrode is divided into part-electrodes having an electric current supplied thereto as successive running waves.
